(19) United States
(12) Patent Application Publication
(10) Pub. No.: US 2021/0004429 A1
(43) Pub. Date: Jan. 7, 2021

(54) METHOD AND SYSTEM FOR DIVERSIFICATION AND DIVERSITY MANAGEMENT OF A GROUP

(71) Applicant: Qatar Investment Authority, Doha (QA)

(72) Inventor: Domenico Mignacca, Doha (QA)

(21) Appl. No.: 16/906,885

(22) Filed: Jun. 19, 2020

Related U.S. Application Data
(60) Provisional application No. 62/869,657, filed on Jul. 2, 2019.

(51) Int. Cl. G06F 17/12; G06Q 40/06; G06Q 10/08; G06Q 50/02; G06Q 50/04; A01G 7/00

(52) U.S. Cl. CPC G06F 17/12; G06Q 40/06; A01G 7/00; G06Q 50/02; G06Q 50/04; G06Q 10/087

(57) ABSTRACT

Methods, systems, and devices for achieving and adjusting the diversity of a population of items, such as memory storage devices, biological species, data objects, or other objects of interest. A desired level of diversification is achieved based upon the quantity of objects in the group and assigned weight, variance, and volatility values for each of the items in the group as well as the group as a whole.

### BACKGROUND

Diversification is a fundamental topic in a variety of areas. For example, automobile vendors may wish to allocate their capital over a wide range of vehicle inventory to maximize appeal to a larger number of potential buyers. Packetized data transmission systems may employ a variety of transmission rates, network paths, and packet sizes in which data may be allocated to reduce the risk of collisions and to increase bandwidth. Data storage systems may fractionally allocate data in a way that maximizes diversity across the model, quantity, and operating duration of each storage device while minimizing loss resulting from device failure.

In considering a set of assets comprising a portfolio, where the expectation of success for all assets is identical, the expected success of an undiversified portfolio will be identical to that of a diversified portfolio. In practice, some assets will perform better than others, but since the individual success of each asset generally cannot be known in advance, the allocation of the assets cannot be tailored to maximize success while minimizing loss.

The success of a diversified portfolio can never exceed that of the best-performing asset and will always be less than the most successful asset. Conversely, the success of a diversified portfolio will also always be higher than that of the worst-performing asset. By diversifying, one avoids the risk of having solely allocated resources into the asset that performs worst, but also loses the chance of having solely allocated resources into the asset that performs best. Diversification narrows the range of possible outcomes and in most cases, will reduce loss.

### BRIEF SUMMARY

Embodiments disclosed herein provide methods, systems, and devices for achieving and adjusting the diversity of a population of items, referred to as a “portfolio”. A desired level of diversification of a portfolio may be achieved by determining a quantity of a plurality of assets in the portfolio; determining a weight for each of the assets of the plurality of assets in the portfolio; determining a variance for each of the assets of the plurality of assets in the portfolio; determining a volatility contribution for each of the assets of the plurality of assets in the portfolio; determining a variance of the portfolio; determining a first diversity index of the portfolio based on the determined quantity of assets, weight, variance, volatility contribution, and variance; determining a second diversity index of the portfolio based on a modification of a metric of the portfolio; and based on a comparison of the first diversity index and the second diversity index, adjusting the portfolio. The assets in the portfolio may include, for example, memory storage devices, biological species, data objects or any other objects of interest. The diversity indices may indicate a diversification of the type of object or device, such as the type of computer memory storage devices. The modification metric used may be, for example, the quantity of assets in the portfolio, the weight of one or more assets, the weight of one or more assets in conjunction with the quantity of assets in the portfolio, or the like. The adjustments made to the portfolio may include, for example, removing an asset or a type of asset from the portfolio, adding an asset or a type of asset to the portfolio, modifying the weight of a one or more assets in the portfolio, replacing a one asset or type of asset with another, or the like.

Additional features, advantages, and embodiments of the disclosed subject matter may be set forth or apparent from consideration of the following detailed description, drawings, and claims. Moreover, it is to be understood that both the foregoing summary and the following detailed description are illustrative and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate embodiments of the disclosed subject matter and together with the detailed description serve to explain the principles of embodiments of the disclosed subject matter. No attempt is made to show structural details in more detail than may be necessary for a fundamental understanding of the disclosed subject matter and various ways in which it may be practiced.

FIG. 1 is a chart showing a relationship between the QDX index and weight of a first asset according to an embodiment of the disclosed subject matter.

FIG. 2 is a chart interpreting the DIV measurement according to an embodiment of the disclosed subject matter.

FIG. 3 is a chart comparing portfolios with varying levels of diversification and hedging according to an embodiment of the disclosed subject matter.

FIG. 4 is a chart showing a geometric interpretation of the QDX index according to an embodiment of the disclosed subject matter.

FIGS. 5A & 5B are charts showing example portfolios having low and high diversification, respectively, according to an embodiment of the disclosed subject matter.

FIG. 6 shows a computing device according to an embodiment of the disclosed subject matter.

FIG. 7 shows a network configuration according to an embodiment of the disclosed subject matter.

FIG. 8 shows an example network and system configuration according to an embodiment of the disclosed subject matter.

### DETAILED DESCRIPTION

The term “portfolio” as used herein refers to a set of assets, which may be one or more similar physical items, assets, computers, memory storage devices, data objects, biological species, agricultural crops, individuals, data objects, musical selections, and the like. Each asset, as used herein, refers to one member of a portfolio. Each asset may be associated with a degree of risk and may have one or more resources allocated to it. As previously discussed, an asset may be, for example, a vehicle in the context of an automobile vendor, where capital is allocated to purchase each vehicle within the vendor's inventory. Risk may arise where a vehicle belonging to the vendor's inventory fails to sell or sells for less than expected. An asset may also be a memory storage device in the context of a data storage system, where data is allocated to one or more memory storage devices. In this example, risk may arise due to the potential data loss that may occur upon failure of a memory storage device.

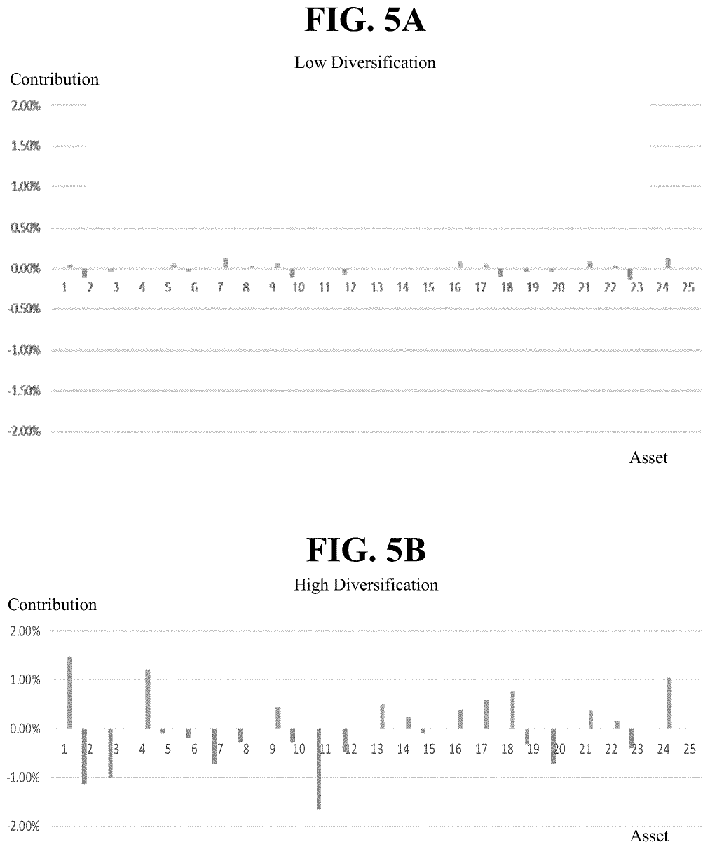

A diversified portfolio may be understood as being less exposed to individual “shocks” imposed by each constituent asset. For example, if each asset of a plurality of assets in a portfolio contributes individually and identically to the portfolio's overall performance, then it may be said that the portfolio is not diversified. FIG. 5A illustrates an example of a portfolio having low diversification where the assets are not substantially dispersed. On the contrary, where the assets are dispersed, it may be said that the portfolio is diversified. FIG. 5B illustrates an example portfolio having high diversification. The question arises as to how to measure the dispersion, or diversification, of the portfolio.

The present subject matter discloses a diversification index to measure the dispersion of the performance contribution of the assets around the portfolio performance. The diversification index QDX may be calculated based on a two-dimensional risk decomposition of portfolio volatility. The QDX may take values in the range [0, 1), where the extremes may signal the lack of, or perfect diversification. The computation is simple to perform in that it may only use the covariance matrix and the portfolio allocation. The QDX may not involve any optimization and straightforward to interpret. The following detailed description also provides the underlying mathematical rationale to assist in extending the QDX index to homogeneous risk measures not related to portfolio volatility.

The present subject matter may apply within the context of an asset portfolio, but the inventors have determined that providing a minimum and/or measurable level of diversification may provide advantages in many non-financial applications, such as in allocating data to memory storage devices, biodiversity in ecological systems, agriculture, manufacturing, and retail inventory selection, forming teams of individuals, selection of type or location of computing resources, or the like.

In biology, for example, the QDX as disclosed herein may be used to measure the biodiversity of an ecosystem. Biodiversity may simultaneously achieve sustainability and systemic healthy by avoiding the abnormal or pathological. Biodiversity may be maximized by determining an appropriately weighted mix of biological species within the system. Specifically, the QDX may be represented as a sum of Rao's Quadratic Entropies using a specific distance measurement, which measures the distance of each species when compared with the remaining species within the system. Therefore, the QDX may help to determine the optimal weighting and selection of biological species to achieve a healthy population.

As another example, data storage may be improved through the QDX diversity measure. Memory storage devices are known to fail after a predetermined amount of time in operation and/or after a predetermined number of read or write cycles. By diversifying the types and locations of memory storage devices such that the data may be distributedly stored, the reliability and security of the data may be improved. For example, a memory allocation diversity scheme employing the QDX may ensure that a minimum threshold size of data is stored in memory storages devices of differing models, age, interconnect, and file system to avoid data loss due to a common defect or vulnerability.

As another example, agriculture may benefit from crop diversification. By diversifying crops, the failure of a single crop to thrive due to drought, insects, or disease may be offset by other crops that may continue to thrive under the same conditions in the same region. Given a set of traits and relationships amongst a given portfolio of crops, the QDX as disclosed herein may be used to calculate and subsequently maximize the crop diversification by aiding in determining the optimal weighting and selection of crops. Use of the QDX may be further expanded to determine an optimal weighting and selection of crops over a plurality of different regions having varying characteristics.

As another example, manufacturing companies that produce a variety of goods may also benefit from diversification. For example, the QDX as disclosed herein may be used to calculate the diversification of the current product offerings over a variety of industrial sectors. Based on the preliminary result, the diversification may be maximized by varying the selection and quantity of product to guard against loss when one or more industrial sectors decline.

As another example, while some institutions may wish to diversify their workforce or academic admissions, other institutions may wish to minimize diversity in, for example, a social guest list. Assuming n groups of individuals, where each group is homogeneous and has a specific correlation with the other groups, the QDX as disclosed herein may be used to measure and maximize, or minimize, the diversification of any mix of the n groups according to any identifiable and measurable traits. For instance, the QDX may be used to compile a guest list including only individuals having an interest in model trains. Similarly, the QDX may be used to compile a group of individuals of interest for a social experiment or behavior analysis.

According to embodiments disclosed herein, the risk decomposition for a given portfolio may be defined. Decomposing the risk associated with an asset may allow for distinguishing the amount of risk associated directly with the specific asset and the amount of risk associated with the fact that there are other assets in the portfolio.

A portfolio may be composed of n risky securities. The volatility a of the portfolio return may be expressed as risk function:

σ=\sqrt{w′Σw}

where Σ is be the n×n covariance matrix with elements σij,i,j=1, . . . , n and w is be the vector of portfolio weights with elements wᵢ.

Given that the risk function is homogeneous of degree one, Euler's theorem may be applied to decompose the portfolio volatility as follows:

$$σ = {\sum }_{j = 1}^{n} {w}_{j} \frac{\partial σ}{\partial {w}_{j}} = {\sum }_{j = 1}^{n} {γ}_{j} \qquad ( 1 )$$

The risk contribution of asset j may be expressed using the quantity:

$${γ}_{j} = {w}_{j} \frac{\partial σ}{\partial {w}_{j}} \qquad ( 2 )$$

The above partial derivatives may be rewritten as covariance between asset and portfolio return, divided by the portfolio volatility, so that

$${γ}_{j} = {w}_{j} \frac{{σ}_{jp}}{σ} = {w}_{j} {σ}_{j} {ρ}_{jp}$$

where ρⱼₚ is the correlation between the return of asset j and the portfolio. The above partial derivatives may be named “marginal contribution” to risk. The quantities γⱼ may sum up to the overall portfolio volatility and named the “component risk.” Each component risk for each asset within the portfolio sums to the overall portfolio volatility.

The diversification at an asset level may be expressed using the following quantity:

$${QDX}_{j} = \frac{{w}_{j}^{2} {σ}_{j}^{2} - {γ}_{j}^{2}}{σ} = \frac{{w}_{j}^{2} {σ}_{j}^{2} ( 1 - {ρ}_{jp}^{2} )}{σ}$$

QDXⱼ, a positive quantity, may measure how much of the variance contributed by the asset j, i.e. ωⱼ²σⱼ², is “diversified away” due to interactions with the other assets, as measured by γⱼ². This quantity of diversification may be measured with respect to the overall portfolio volatility. Given QDXⱼ, we can then compute a diversification measure at the portfolio level as:

$$QDX = {\sum }_{j = 1}^{n} Q \vert {DX}_{j} \qquad ( 3 )$$

Conceptually this indicates that an asset having a low correlation with the portfolio provides a diversification benefit. Similarly, if the asset has a large correlation with the portfolio, it will not contribute to diversification of risk due to the other assets. A poorly diversified portfolio may be characterized by assets having a squared risk contribution similar to the weighted variance and a low value of QDXj. In contrast, in a well-diversified portfolio, the risk contributions of each of the different assets may approach zero, while QDXⱼ may reach relatively large values.

The risk contribution of each asset may be a homogeneous function of degree one and may be decomposed as follows:

$${γ}_{j} = {w}_{j} \frac{\partial {γ}_{j}}{\partial {w}_{j}} + {\sum }_{k = 1 , k \neq j}^{n} {w}_{k} \frac{\partial {γ}_{j}}{\partial {w}_{k}}$$

It may be shown that:

$${w}_{j} \frac{\partial {γ}_{j}}{\partial {w}_{j}} = {γ}_{j} + \frac{1}{σ} ( {w}_{j}^{2} {σ}_{j}^{2} - {γ}_{j}^{2} ) = {γ}_{j} + {DIV}_{j}$$

$$and$$

$${\sum }_{k = 1 , j \neq k}^{n} {w}_{k} \frac{\partial {γ}_{j}}{\partial {w}_{k}} = \frac{1}{σ} {\sum }_{k = 1 , j \neq k}^{n} ( {w}_{k} {w}_{j} {σ}_{jk} - {γ}_{j} {γ}_{k} ) < 0$$

Due to the homogeneity of the risk function, this second component may exactly offset DIVⱼ:

$${DIV}_{j} = - \frac{{\sum }_{k = 1 , j \neq k}^{n} ( {w}_{k} {w}_{j} {σ}_{jk} - {γ}_{j} {γ}_{k} )}{σ}$$

QDXⱼ may be understood as the quantity of risk related to asset j that can be diversified via the interaction with the remaining assets. Therefore:

γⱼ=γⱼ+QDXⱼ−DIVⱼ (4)

Expression (4) may describe that the risk contribution of an asset j, if the asset may be considered alone in the portfolio, may be measured by the amount γᵢ+QDXⱼ. The interaction of the asset j with the remaining assets allows a complete offset of the component QDXⱼ, leaving γⱼ as the effective risk contribution of the asset j. Therefore, QDXⱼ, a positive quantity, may be the additional contribution to the portfolio risk of the j^{th} asset if this asset is considered alone in the portfolio. The second component, which takes negative values, may measure the reduction to the risk contribution of the j^{th} asset given that the asset is considered in a portfolio context. Indeed, it may be shown that:

$$QDX = \frac{{\sum }_{j = 1}^{n} ( {w}_{j}^{2} {σ}_{j}^{2} - {γ}_{j}^{2} )}{σ} = \frac{{\sum }_{j = 1}^{n} {\sum }_{k = 1 , j \neq k}^{n} ( {w}_{k} {w}_{j} {σ}_{jk} - {γ}_{j} {γ}_{k} )}{σ} \\ and \\ DIV = {\sum }_{k = 1}^{n} {DIV}_{k} \\ Therefore , \\ σ = σ + QDX - DIV \qquad ( 5 )$$

may be provided as an expression that may not be taken as a simple accounting equality. This decomposition is not arbitrary and may be valid whenever the risk-measure is homogeneous of order one. The undiversified volatility of the portfolio may be expressed as σ+QDX and DIV is measuring the diversification component.

Based on the QDX measure, a new diversification component, Q̅D̅X̅. may be defined by taking the ratio between the quantity of diversification relative to the single asset and the overall portfolio undiversified risk:

$${\overline{QDX}}_{j} = \frac{{DIV}_{j}}{σ + QDX}$$

This ratio may be computed at portfolio level as well:

$$\overline{QDX} = {\sum }_{j = 1}^{n} {\overline{QDX}}_{j} = \frac{DIV}{σ + QDX}$$

Additional support for the use of QDX as measure of diversification may be obtained by considering the linear regression of each weighted asset return on the portfolio return:

wⱼrⱼ=βⱼrₚ+εⱼ,j=1, . . . ,n

The coefficient of the least-square fit may be expressed as:

$${\hat{β}}_{j} = \frac{{w}_{j} {σ}_{j} {ρ}_{ip}}{σ} = \frac{{γ}_{j}}{σ}$$

and Σⱼ₌₁ⁿ\hat{β}ⱼ=1. Moreover, the partial variances of the residuals of each regression, given the portfolio return, may be expressed as:

V(εⱼ|rₚ)=wⱼ²σⱼ²−γⱼ²=DIVⱼσ

This quantity in statistics is known as “partial variance.” In this context, it may be considered a measure of the risk remaining when an item is added to a portfolio. If returns are jointly Gaussian, the partial variance may coincide with the conditional variance, whose calculation may include the knowledge of the joint distribution of the asset and the portfolio returns. If the partial variance is large, it may mean that the asset contributes a risk different from the one explained by the portfolio. That is, the asset mqy have a quantity of risk orthogonal to the portfolio return, so it may be of some help in diversifying risk across assets. The opposite may be true when the partial variance is low. More precisely, the greater the partial variance, the greater the possibility of reducing the idiosyncratic risk that is not driven by the portfolio-mixing different assets. The sum of these residual/partial variances may be considered as a measure of the portfolio diversification, as expressed in equation (6):

$${QDX}_{j} = \frac{1}{σ} V ( {ɛ}_{j} \vert {r}_{p} ) \qquad ( 6 )$$

Expression (6) may illustrate how to partition the diversification measure among the individual holdings. When measuring the diversification effect of an asset, the partial variance of each asset may be considered rather than the variance to control for the portfolio return. Consider the covariance between residuals of the projection of wⱼ rⱼ and wₖ rₖ on the linear space spanned by the portfolio return. This quantity in statistics is known as “partial covariance” and may be expressed as:

Cov(∃ⱼ,εₖ|rₚ)=wⱼwₖσⱼₖ−γⱼγₖ

Summing over k, k≠j DIVⱼ may be expressed as shown in expression (7):

$${DIV}_{j} = - \frac{1}{σ} {\sum }_{k = 1 , k \neq j}^{n} Cov ( {ɛ}_{j} , {ɛ}_{k} \vert {r}_{p} ) \qquad ( 7 )$$

Expressions (6) and (7) may indicate that DIV₁ may be the diversification contribution of the individual holding to the overall portfolio amount of diversification as measured by the QDX. In measuring the diversification effect of an asset, the portfolio return needs to be controlled for, such that the diversification contribution of an asset is related to the partial covariance of that asset with the remaining assets rather than their covariances. This may be confirmed when noticing that in the decomposition formula the covariances among the residuals allow for the elimination of the idiosyncratic variances:

$${σ}^{2} = {σ}^{2} + {\sum }_{j = 1}^{n} V ( {ɛ}_{j} \vert {r}_{p} ) + {\sum }_{k = 1 , k \neq j}^{n} Cov ( {ɛ}_{j} , {ɛ}_{k} \vert {r}_{p} )$$

This decomposition may be interpreted as a statistical version of the Euler's theorem when the risk is measured by the portfolio standard deviation. This decomposition holds if the regression is made with respect to the given portfolio. For example, if the regression is performed on some market portfolio, the above decomposition does not hold. It may be similarly seen that in a multifactor world, the only thing that may matter for diversification is the residual volatility that is not explained by the factors. In this context, the factor is the portfolio return itself and in practice, there is no residual volatility if the portfolio is entirely invested in a stock only. This is indeed the case when there is no benefit at all from diversifying. Therefore, according to the QDXⱼ measure, the volatility that may be diversified comes from the correlation with the overall portfolio. In order to build a well-diversified portfolio, it may be important to assign the portfolio weights so that the assets give the same contribution, as measured by the partial variances, to the overall QDX value, rather than by looking to the correlation across assets. Eventually, the only benefit would come from enhancing the portfolio expected return for a given volatility level rather than from diversifying risk.

The decomposition may also be related to a diversification measure using a regression approach similar to the one just described. The starting point may be a linear regression of the asset return with respect to the market return:

rⱼ=bⱼrₘ+εⱼ

Next, assuming that the εⱼ are independent across securities, the non-market risk of the portfolio may be expressed as:

$${\sum }_{j = 1}^{w} {w}_{j}^{2} {σ}_{{ɛ}_{j}}^{2}$$

This operates a rescaling of this quantity using any more or less arbitrary chosen “typical level of non-market risk, designated as σ*:

$${\sum }_{j = 1}^{n} {w}_{j}^{2} {σ}_{{ɛ}_{j}}^{2} = {( {σ}^{*} )}^{2} {\sum }_{j = 1}^{n} {{w}_{j}^{2} ( \frac{{σ}_{{ɛ}_{j}}}{{σ}^{*}} )}^{2}$$

Finally, the scaled relative non-market risk of security j may be defined using the ratio

$${λ}_{j} = \frac{{σ}_{{ɛ}_{j}}}{{σ}^{*}}$$

and recovers a diversification measure as:

$$D = \frac{1}{{\sum }_{j = 1}^{n} {( {w}_{j} {λ}_{j} )}^{2}} \qquad ( 8 )$$

The specific measure of the non-market risk of a portfolio may be approximated using the standard error of its return, so that:

$$\frac{\sqrt{{\sum }_{j = 1}^{n} {w}_{j}^{2} {σ}_{{ɛ}_{j}}^{2}}}{σ} = \frac{1}{\sqrt{D}}$$

and then D=σ²/(Σⱼ₌₁ⁿwⱼ²σ_{ε}_{ⱼ}²). Therefore, if the portfolio under examination is the market portfolio and the typical non-market risk is equal to σ, it may be shown that:

$$QDX = \frac{σ}{D}$$

The diversification index DIV disclosed herein may improve on prior formulations in several ways. For one, the DIV may be clearly derived by exploiting the homogeneity property of the volatility measure. The DIV may also be less subjective because it is independent in terms of the choice of market (benchmark) and in terms of the measurement of the typical non-market risk, which may not be readily available. The DIV may be computed using the partial variances and covariances, i.e. by controlling for the portfolio effect. The DIV may be transformed in standardized measure-taking values in [0, 1). The described embodiments of the present subject matter reveal that the DIV may be easily and intuitively calculated. Additionally, it should be appreciated that the DIV is not limited to any subject matter area and may be broadly applicable to a variety of risk measures, as will be subsequently described.

Consider the following covariance matrix, for example:

$$\sum = [ \begin{matrix}1000 & 400 & 400 \\ 400 & 1000 & 400 \\ 400 & 400 & 1000\end{matrix} ]$$

In this example, the correlation between any pair of assets is constant and equal to 0.4. The variance of each asset is 1000. Continuing the example, suppose two portfolios are selected. The first portfolio has weights [0.5 0.5 0]′ and variance 700. The second portfolio has weights [0.5 0.25 0.25]′ and variance 625. Based on the portfolio weights, it may initially appear that the second portfolio is more diversified than the first because, assuming the assets have the same characteristics, it more uniformly allocates the wealth across assets. Applying the DIV to the first and second portfolios instead reaches an opposite and non-obvious result, shown below:

$${DIV}_{1} = \frac{150}{\sqrt{700}} = 5.67 , {DIV}_{2} = \frac{118.50}{\sqrt{625}} = 4.74$$

The result may be better understood by computing partial covariances and partial correlations between assets, given the portfolio return. As suggested previously, the partial covariances and partial correlations may be more compelling than the variances and covariances. Partial covariance may measure the covariance between two random variables, with the effect of a controlling random variable removed; in this example, the controlling random variable may correspond to the portfolio return. Given the first portfolio, the matrix Σ_{⋅|rp} of the partial covariances, the DIVⱼ's, and the matrix R_{⋅|rp} of partial correlations may be respectively expressed as:

$${\sum }_{\cdot \vert {r}_{p}} = [ \begin{matrix}300 & - 300 & 0 \\ - 300 & 300 & 0 \\ 0 & 0 & 771\end{matrix} ]$$

$${DIV}_{j} = [ \begin{matrix}2.83 \\ 2.83 \\ 0.000\end{matrix} ]$$

$${R}_{\cdot \vert {r}_{p}} = [ \begin{matrix}100 \% & - 100 \% & 0 \% \\ - 100 \% & 100 \% & 0 \% \\ 0 \% & 0 \% & 100 \%\end{matrix} ]$$

Given the second portfolio, the partial covariances, the DIVⱼ's, and partial correlations may be expressed as:

$${\sum }_{\cdot \vert {r}_{p}} = [ \begin{matrix}216 & - 216 & - 216 \\ - 216 & 516 & - 84 \\ - 216 & - 84 & 516\end{matrix} ]$$

$${DIV}_{j} = [ \begin{matrix}2.16 \\ 1.29 \\ 1.29\end{matrix} ]$$

$${R}_{\cdot \vert {r}_{p}} = [ \begin{matrix}100 \% & - 65 \% & - 65 \% \\ - 65 \% & 100 \% & - 16 \% \\ - 65 \% & - 16 \% & 100 \%\end{matrix} ]$$

Regarding the first portfolio, the partial correlation between asset 1 and asset 2 is −1, and the asset returns, given the portfolio return, are orthogonal. A greater diversification effect may be obtained by investing in the first two assets. Regarding the second portfolio, the partial correlations are also negative, but with less magnitude than in the first portfolio. This is reflected in the DIVⱼ measures for each asset, which are larger in the first portfolio. Controlling for portfolio return, the DIV may provide a better representation of the interactions between assets.

Based on the previously discussed decomposition expression, a new diversification index may be defined, known as QDX, by taking the ratio between the quantity of diversification and the portfolio risk, assuming each asset is considered alone in the portfolio. It may be expressed as:

$$DIV = \frac{- \frac{{\sum }_{j = 1}^{n} {\sum }_{k = 1 , j \neq k}^{n} ( {w}_{k} {w}_{j } {σ}_{jk} - {γ}_{j} {γ}_{k} )}{σ}}{{σ}^{2} + \frac{{{\sum }_{i = 1}}^{n} ( {w}_{j}^{2} {σ}_{j}^{2} - {γ}_{j}^{2} )}{σ}}$$

or equivalently as:

$$QDX = \frac{{\sum }_{i = 1}^{n} ( {w}_{i}^{2} {σ}_{i}^{2} - {γ}_{i}^{2} )}{{σ}^{2} + {\sum }_{i = 1}^{n} ( {w}_{i}^{2} {σ}_{i}^{2} - {γ}_{i}^{2} )} ,$$

or in a more incisive way as:

$$QDX = \frac{DIV}{VOL + DIV} \qquad ( 9 )$$

In equation (9), VOL is the portfolio volatility σ. Clearly, QDX is always less than 1. Moreover, being a ratio of positive quantities, QDX is always greater than zero, which may be expressed as:

0≤QDX<1

When QDX=0, it may signal a lack of diversification. When QDX=1, it may signal perfect diversification due to the singular covariance matrix. Diversification may be minimized when the portfolio is fully invested in a single stock. Taking the example of a single stock, w₁=1 and wⱼ=0, j=2, . . . , n. As a result, VOL=σ₁, γ₁=σ₁, γᵢ=0, i=2, . . . , n, DIV=0, and the QDX is equal to 0. In contrast, maximum diversification may occur if the portfolio volatility goes to zero. This may imply that the QDX approaches the 100% limit. Notice that the limit is well-defined. Indeed, if the QDX measure is written QDX=1−VOL2/(VOL2+DIV), then it is clear that QDX will approach 1 as VOL approaches 0. For example, in the two-asset example previously discussed, if the two assets are perfectly negatively correlated, a zero-variance portfolio may be constructed where, through simple algebra, the QDX may be shown equal to 1. In general, the QDX may approach 1 when the covariance matrix is semi-definite positive, so that it may be possible to find a portfolio composition having 0 portfolio volatility VOL.

QDX may distinguish between the benefits of diversification (QDX<50%) and the benefits of hedging (QDX>50%). Where the assets are positively-correlated, and the weights are non-negative, the overall risk may be reduced by exploiting the non-perfect correlation across assets such that the QDX remains constrained to less than or equal to 50%. The QDX may be greater than 50% whenever DIV>σ, or equivalently when:

$${\sum }_{j = 1}^{n} ( {w}_{j}^{2} {σ}_{j}^{2} - {γ}_{j}^{2} ) > {\sum }_{i , j = 1}^{n} {w}_{i} {w}_{j} {σ}_{i , j} = {\sum }_{j = 1}^{n} {w}_{j}^{2} {σ}_{j}^{2} + {\sum }_{i = 1} {{\sum }_{j = 1 , i \neq j}}^{n} {w}_{i} {w}_{j} {σ}_{i , j}$$

This happens if and only if:

$${{\sum }_{i , j = 1 , i \neq j}}^{n} {w}_{i} {w}_{j} {σ}_{i , j} < - {\sum }_{j = 1}^{n} {γ}_{j}^{2}$$

If the weights and the covariances are positive, the aforementioned condition may never occur, and the QDX may not exceed 50%. Hedging benefits, due to negative weights or negative correlations, may result in the QDX exceeding 50%.

The relevance of the 50% threshold can be understood by considering a covariance matrix that is a multiple of the identity matrix, i.e., by assuming that the assets are uncorrelated and have the same variance. In this case, the maximum QDX value may be 50%. This may occur where the portfolio is equally diversified and has little variance. In this example, the portfolio variance is σ2/n, the risk contributions are the DIV measure is γᵢ=σ/(n\sqrt{n}), and QDX=(n−σ²(n−1)\sqrt{n}/n²)1/(2n−1) approaches 50% for large n. More precisely, the 50% threshold varies depending on portfolio size: QDX may rise to 33% for a portfolio made of just two assets and increase to 50% for a portfolio having an infinite number of assets.

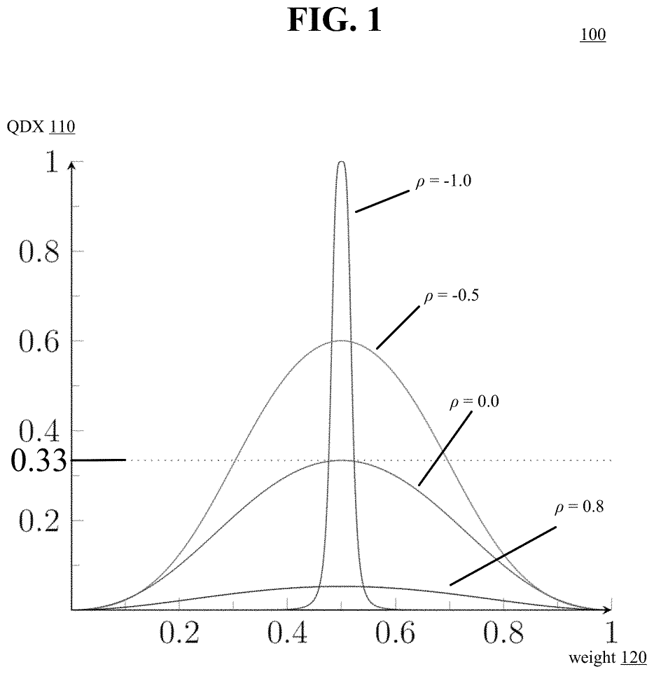

FIG. 1 is a chart 100 illustrating the QDX index 110 as a function of the weight 120 of a first asset in a portfolio of two homogeneous assets, where each asset may have the same variance and correlation p. For example, if the weight 120 of the first asset is 0.2 (20%), then the weight of the second asset (not shown) is 0.8 (80%). If the correlation p is negative, QDX values larger than 0.5 may be achieved. For ρ=−1, the QDX of an equally weighted portfolio is 1. It can be seen from chart 100 that as ρ→1, the QDX goes to 0. The dotted line may represent the maximum achievable threshold value of the QDX when ρ=0, i.e. 33%, with an equally weighted portfolio. In practice, this threshold may be exceeded with a portfolio having just 10 assets (for which QDX=47%). The two extremes cases may occur for an equally weighted portfolio where ρ=1 and QDX=0, and where ρ=<1 and QDX=1. The 33.3% threshold may be met when ρ=0, and each asset is equally weighted at 50%. If ρ>0, then QDX may be less than 33.3%. On the other hand, if ρ<0 (see ρ=−0.5), then QDX may exceed 33.3% if each asset is remains weighted approximately between 30% and 70%.

A portfolio may also contain negatively correlated assets. In that case, the QDX, as shown in FIG. 1, may take values reach values as large as 100%. This may occur whenever the covariance matrix is singular, so that the portfolio manager may perfectly balance the portfolio risk, thereby reducing the portfolio volatility to zero. Notice that the limit may be well-defined. For example, if the QDX measure is rewritten as QDX=1−VOL2/(VOL2+DIV), it may be seen that as VOL goes to zero, the QDX approaches 1. For example, in the two-asset case, if the two assets are perfectly negatively correlated, a zero-variance portfolio can be constructed where the QDX is equal to 1.

Therefore, for large portfolios, a value of QDX greater than 50% may signal that the portfolio manager is hedging, i.e. taking short positions in some assets or investing in negatively-correlated assets. The hedging benefit may be measured by QDX−0.5. In practice, given that it may be difficult to find negatively correlated assets, values of QDX larger than 50% may signal that the portfolio manager is short-selling assets.

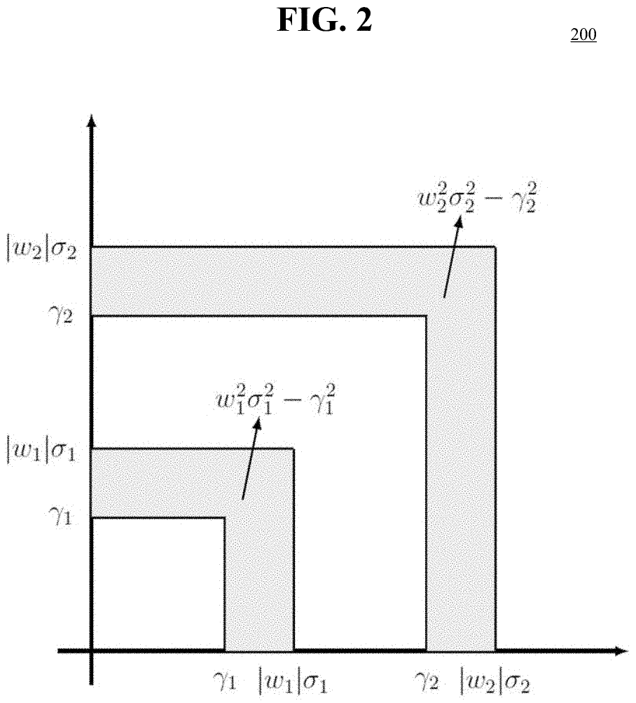

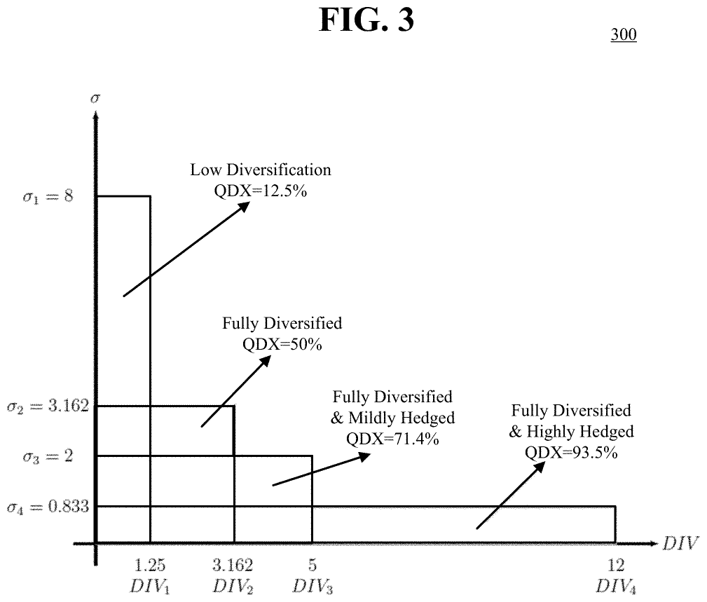

FIG. 3 is a chart plotting four rectangles that may each represent a portfolio with respect to volatility a and diversification DIV. The x-axis length may be equal to DIV/σ and the y-axis length may be equal to portfolio volatility a. Again, the area of the different rectangles is equal to Σⱼ₌₁ⁿ(wⱼ²σⱼ²−γⱼ²) i.e., the shaded region of FIG. 2. In general, it may be that the shorter the length along the x-axis, the less diversified the portfolio. Conversely, the longer the length along the y-axis, the more volatile the portfolio. Where QDX=50% (0.5), the rectangle may be fully diversified and may achieve the maximum benefit from diversification, given positive portfolio weights and non-negative covariances. The rectangles where QDX=71.4% and 93.5%, respectively, represent portfolios that achieve hedging benefits by exploiting negative weights and/or negative covariances. Where QDX is less than 50%, portfolios may be only exploiting the non-perfect correlation among assets.

The QDX index may also be useful in quantifying the diversification impact of each asset in absolute terms:

$${QDX}_{i} = \frac{{DIV}_{i}}{σ + DIV} \qquad ( 10 )$$

It may also be used to quantify the diversification impact in relative terms:

$${QDX}_{i}^{( \% )} = \frac{{QDX}_{i}}{QDX} \qquad ( 11 )$$

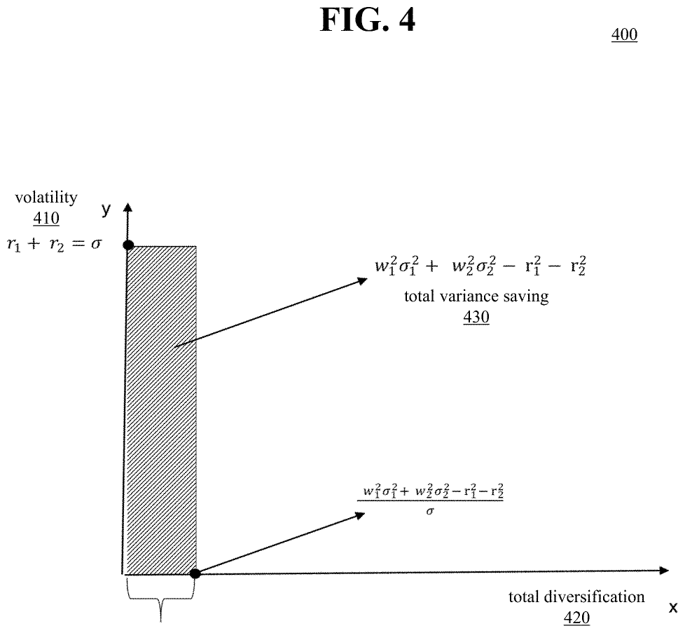

FIG. 4 is a chart 400 showing a geometric interpretation of the QDX index. The volatility 410 of the profile may be represented by the length along the y-axis (σ). The shaded area 430 may represent the total amount of variance being “saved” because of diversification. Accordingly, the ratio of the shaded area with the y-axis length may represent the total diversification 420

$$( \frac{{w}_{1}^{2} {σ}_{1}^{2} + {w}_{2}^{2} {σ}_{2}^{2} - {r}_{1}^{2} - {r}_{2}^{2}}{σ} ) .$$

The DIV and the QDX measures may not be invariant with respect to the considered dimension, such as with respect to assets, sub-portfolios and factors. To illustrate, suppose that two sub-portfolios have the same composition, are perfectly correlated, and are invested in many assets, such that each sub-portfolio has a QDX equal to 1. Next, suppose that a new portfolio is created investing 50% in each of the two sub-portfolios. Computing the QDX with respect to the asset dimension each sub-portfolio will result in a QDX of 1, however, computing the QDX with respect to the sub-portfolio dimension will result in a QDX of 0. Therefore, this example shows that diversification may be a relative concept that depends on the point of view. This concept is discussed in more detail in Appendix B with reference to the factor model:

r=B′f=ε (12)

B is the f×n matrix of factor loadings, and wf=Bwn collects the factor exposures. For example, consider a portfolio composed of several sub-portfolios, where wₛ is an s×1 vector containing the weights of sub-portfolios over the total portfolio, and where 1′ₛwₛ=1. This portfolio may be related to wₙ by introducing a n×s matrix C, such that Cwₛ=wₙ. In this way, given the factor model, the risk of the portfolio may be decomposed along three different dimensions: (i) assets (wₙ), (ii) sub-portfolios (wₛ) and (iii) factors (w_{f}). Additional discussion is provided in sub-sections B.1-B.3.

It has been found that different diversification measures as disclosed herein may give opposite results. Consider a covariance matrix having the structure:

Σ=(1−c)σ2Iₙ+cσ₂1ₙ1′ₙ (13)

In expression (13), Iₙ is the identity matrix of order n, and 1ₙ is the unit column vector of order n. This means that the assets may have a constant correlation coefficient c>0 and a constant volatility a. Using the spectral decomposition of the covariance matrix, it may be verified that the equally diversified portfolio 1ₙ/n is an eigenvector of the covariance matrix,

$$( \sum \frac{{1}_{n}}{n} = ( ( 1 - c ) {σ}^{2} {I}_{n} + c {σ}^{2} {1}_{n} {1}_{n}^{′} ) \frac{1}{n} = ( ( 1 - c ) {σ}^{2} + c {σ}^{2} n ) \frac{{1}_{n}}{n} = {λ}_{n} \frac{{1}_{n }}{n} ) ,$$

with corresponding variance (eigenvalue):

λₙ=((1−c)+cn)σ² (14)

Due to the orthogonality of the eigenvectors, the exposure of this portfolio to the remaining factors may be equal to zero. Therefore, the equally weighted portfolio may concentrate the risk in one factor only. As n increases, the variance of this factor, given in expression (14), may become larger than the variance of the remaining factors. The remaining factors may have eigenvalues, corresponding to variances, equal to:

λᵢ=(1−c)σ²,i=1, . . . ,n−1 (15)

In other words, given the covariance structure in expression (13), an equally weighted portfolio may have positive exposure to the most important factor and may have zero exposure to all the remaining factors. The variance of the first factor may increase with the number of assets. In practice, given the assumed covariance matrix structure, the equally diversified portfolio may exhibit low diversification. This fact may be recognized by our diversification indicator QDX, that, for large n behaves equivalently to:

$$\frac{1 - c}{c} \frac{1}{n} \qquad ( 16 )$$

From expression (16), it may be seen that for large n, the QDX approaches zero. Some algebra shows that for large n, the portfolio variance approaches cσ², the coefficient

$${γ}_{j} \frac{\sqrt{c {σ}^{2}}}{n} ,$$

behaves as and by using wᵢ=1/n, expression (16) may be obtained. It may also be observed that as the correlation c between assets increases (reduces) in absolute value, the QDX decreases (increases), as one should expect. The same property holds for the ENB measure as well. In particular, in the case of the limit as c approaches 0, our QDX measure approaches 0.5.

The Diversification Ratio (DR) is a popular index adopted in the industry. It is defined as the ratio of the weighted average volatility of individual securities in a portfolio divided by the volatility of the portfolio. The higher the Diversification Ratio, the more diversified the portfolio. Given the structure of the covariance matrix, as previously discussed, the DR index of an equally weighted portfolio may be expressed as:

$$DR = \frac{1}{\sqrt{( 1 - c ) \frac{1}{n} + c}}$$

As n increases, this index increases up to the limit given by

$$\frac{1}{\sqrt{c}} ,$$

which may signal a more diversified portfolio. This result surprisingly contradicts what one would expect.

### IV. Extension to Other Homogeneous Risk Function

In this section, the mathematical background of the QDX index will be provided. In particular, the QDX index may be obtained by a more general formula that is valid whenever the risk measure is homogeneous of degree one. The QDX index may be applied to any risk measure that is homogeneous of degree one, such as value at risk and expected shortfall.

Whenever the risk measure R(w): Rⁿ→R is homogeneous of degree one, then the risk-contribution

$${γ}_{j} = {w}_{j} \frac{θℛ ( w )}{θ {w}_{j}}$$

is also homogeneous of degree one in the portfolio weights. The partial derivative of the risk function R(w) is homogeneous of degree zero. Multiplying it by the weight still results in a homogeneous function of degree one. Therefore, it follows that:

$$\begin{matrix}ℛ ( w ) = {\sum }_{j = 1}^{n} {γ}_{j} = {\sum }_{j = 1}^{n} {\sum }_{k = 1}^{n} {w}_{k} \frac{\partial {γ}_{j}}{\partial {w}_{k}} = {\sum }_{j = 1}^{n} {γ}_{jj} + {\sum }_{j = 1}^{n} {\sum }_{k = 1 , k \neq j}^{n} {γ}_{jk} & ( 17 ) \\ where & \\ {γ}_{jj} = {w}_{j} \frac{\partial {γ}_{j}}{\partial {w}_{j}} = {w}_{j} \frac{\partial ℛ ( w )}{\partial {w}_{j}} + {w}_{j}^{2} \frac{{\partial }^{2} ℛ ( w )}{{\partial }^{2} {w}_{j}} = {γ}_{j} + {w}_{j}^{2} \frac{{\partial }^{2} ℛ ( w )}{{\partial }^{2} {w}_{j}} & ( 18 ) \\ and & \\ {γ}_{jk} = {w}_{j} \frac{\partial {γ}_{j}}{\partial {w}_{k}} = {w}_{k} {w}_{j} \frac{{\partial }^{2} ℛ ( w )}{\partial {w}_{k} \partial {w}_{j}} & ( 19 )\end{matrix}$$

Using expressions (18), (19), Σᵢ₌₁ⁿγᵢ= [symbol] (w), and it follows that:

$$ℛ ( w ) = ℛ ( w ) + {\sum }_{j = 1}^{n} {w}_{j}^{2} \frac{{\partial }^{2} ℛ ( w )}{{\partial }^{2} {w}_{j}} + {\sum }_{j = 1}^{n} {\sum }_{k = 1 , k \neq j}^{n} {w}_{j} {w}_{k} \frac{{\partial }^{2} ℛ ( w )}{\partial {w}_{k} \partial {w}_{j}} \qquad ( 20 )$$

and therefore, it must hold that:

$${\sum }_{j = 1}^{n} {w}_{j} \frac{{\partial }^{2} ℛ ( w )}{{\partial }^{2} {w}_{j}} = - {\sum }_{j = 1}^{n} {\sum }_{k = 1 , k \neq j}^{n} {w}_{k} \frac{{\partial }^{2} ℛ ( w )}{\partial {w}_{k} \partial {w}_{j}} \qquad ( 21 )$$

The asset n² risk decomposition may be expressed using matrix notation:

$$γ = [ \begin{matrix}{γ}_{1} \\ … \\ {γ}_{i} \\ … \\ {γ}_{n}\end{matrix} ] = [ \begin{matrix}{\sum }_{k = 1}^{n} {w}_{1} \frac{\partial {γ}_{1}}{\partial {w}_{k}} \\ … \\ {\sum }_{k = 1}^{n} {w}_{2} \frac{\partial {γ}_{i}}{\partial {w}_{k}} \\ … \\ {\sum }_{k = 1}^{n} {w}_{n} \frac{\partial {γ}_{n}}{\partial {w}_{k}}\end{matrix} ] = [ \begin{matrix}{w}_{i} \frac{\partial {γ}_{1}}{\partial {w}_{1}} … {w}_{i} \frac{\partial {γ}_{1}}{\partial {w}_{n}} \\ {w}_{i} \frac{\partial {γ}_{i}}{\partial {w}_{1}} … {w}_{i} \frac{\partial {γ}_{i}}{\partial {w}_{n}} \\ {w}_{n} \frac{\partial {γ}_{n}}{\partial {w}_{1}} … {w}_{n} \frac{\partial {γ}_{n}}{\partial {w}_{n}}\end{matrix} ] [ \begin{matrix}1 \\ … \\ 1 \\ … \\ 1\end{matrix} ] = {W}_{n} \frac{\partial γ}{\partial w} {1}_{n} , \qquad ( 22 )$$

where Wₙ [symbol] =1′ₙγ. is a n×n diagonal matrix

$${W}_{n} \frac{\partial γ}{\partial w}$$

having on the main diagonal the portfolio weights, 1 is the unit vector and The elements γⱼₖ, j≠k on the diagonal of in matrix (22) are the quantities yⱼⱼ given in (18), while the off-diagonal elements are the quantities given in expression (19). Accordingly, the generalized DIV measure may be expressed as:

$$DIV ( w ) = {\sum }_{j = 1}^{n} {w}_{j}^{2} \frac{{\partial }^{2} ℛ ( w )}{{\partial }^{2} {w}_{j}}$$

where:

R(w)=R(w)+DIV(w)−DIV(w)

and the QDX index may be expressed as:

$$QDX ( w ) = \frac{DIV ( w )}{RISK + DIV ( w )} . \qquad ( 23 )$$

In expression (23), RISK references R(w). Therefore, the DIV measure may be strictly related to the convexity of the risk function. Trivially, a risk function that is linear in the weights may not allow for diversification. In this case, the DIV and QDX index may assume the value of 0. The more convex the risk function is, the larger the second derivatives, and therefore, the DIV index. In a perfectly diversified portfolio, the risk may be zero, and the QDX may be 1. Moreover, being a ratio of positive quantities, the QDX is also positive and has a range expressed as [0, 1). It should be further noted that the QDX is larger than 50%, if and only if:

DIV>RISK

i.e., whenever

$${\sum }_{j = 1}^{n} {\sum }_{k = 1 , k \neq j}^{n} {w}_{j} {w}_{k} \frac{{\partial }^{2} σ}{\partial {w}_{j} \partial {w}_{k}} < - RISK$$

and, if the risk measure is a positive quantity as usual, the aforementioned condition can be satisfied only if the portfolio includes negative weights or the mixed derivative is negative. In addition, the diversification impact of each asset may be expressed as:

$${QDX}_{i} = \frac{{γ}_{ii} - {γ}_{i}}{{\sum }_{j = 1}^{n} {γ}_{jj}} , ∀ i = 1 , … , n . \qquad ( 24 )$$

and in relative terms as:

$${QDX}_{i}^{( \% )} = \frac{{QDX}_{i}}{QDX} \qquad ( 25 )$$

Where the risk measure ia the portfolio volatility, R(w)=σ(w)=\sqrt{w′Σw}, it follows that:

$${\sum }_{j = 1}^{n} {γ}_{jj} = σ + {\sum }_{j = 1}^{n} \frac{{w}_{j}^{2} {σ}_{j}^{2} - {γ}_{j}^{2}}{σ}$$

$$and$$

$${\sum }_{j = 1}^{n} {\sum }_{k = 1 , j \neq k}^{n} {γ}_{jk} = - {\sum }_{j = 1}^{n} \frac{{w}_{j}^{2} {σ}_{j}^{2} - {γ}_{j}^{2}}{σ}$$

$$so that \text{:}$$

$$DIV ( w ) = {\sum }_{j = 1}^{n} \frac{{w}_{j}^{2} {σ}_{j}^{2} - {γ}_{j}^{2}}{σ}$$

The QDX index in expression (23) corresponds to the one given in expressions (3-9).

The DIV and QDX may be easily adapted to deal with other risk measures homogeneous of degree one, such as Value at Risk (VaR) and Expected Shortfall (ES). For example, using as risk-measure the portfolio VaR and assuming asset returns are not Gaussian, the DIV requires the computation of the quantities:

$${γ}_{i} = {w}_{i} \frac{\partial V a R}{\partial {w}_{i}}$$

$$And \text{:}$$

$${γ}_{ii} = {w}_{i} \frac{{\partial }^{2} V a R}{\partial {w}_{i}^{2}} , i = 1 , … , n$$

The expressions for the first and second-order derivatives are given in Property 1 as described in Gourieroux et al. (2000). The first derivative of the VaR with respect to the portfolio allocation may be computed according to the expression:

$$\frac{\partial V a R}{\partial {w}_{i}} = {γ}_{i} = - {w}_{i} E ( {r}_{i} \vert {r}_{p} = - V a R )$$

The second derivative of the VaR, while more complicated, still relates to the partial variance:

VaR(rᵢ|rₚ=−VaR)

This result formed the basis to justify the use of the DIV measure in section I via the orthogonal projection of the weighted asset return on the portfolio return. A similar expression holds when the Expected Shortfall is adopted as risk measure.

The QDX measure may be used to build a well-diversified portfolio. One possible solution may maximize QDX or Q̅D̅X̅. However, this may be inconvenient because the portfolio may end up concentrated in a few assets, i.e., the ones having the largest partial variances and the lowest partial correlations, which may be well-known to affect Markowitz portfolios. A portfolio whose undiversified volatility may be highly concentrated on a few assets may be considered poorly diversified, whereas a portfolio that has a QDX measure evenly distributed across assets may be considered well-diversified. Therefore, a solution may be to diversity diversification across assets, adopting a parity approach. Stated another way, a portfolio may be built in which the partial variances' contributions to the overall portfolio QDX are equally distributed across assets. Therefore, the ratio Rⱼ may be defined between the quantity of diversification relative to the single asset, QDXⱼ and the overall portfolio amount of diversification QDX:

$${R}_{j} = \frac{{QDX}_{j}}{QDX} = \frac{{\overline{QDX}}_{j}}{\overline{QDX}}$$

and then portfolio allocation may be searched such that:

$${R}_{j} = \frac{1}{n} , ∀ j \qquad ( 26 )$$

The aim may be to diversify diversification equally across assets. In order to achieve this objective, it may be measured how far a given portfolio is from the ideal situation given in equation (26) by computing the following entropy quantity:

$$𝒩 := {𝒩}^{( w , \sum )} = exp ( - {\sum }_{i = 1}^{n} {R}_{j} ln ( {R}_{j} ) ) \qquad ( 27 )$$

whose maximum value may be n and may be obtained when the diversification parity condition is satisfied. The minimum value may be 1 and may be obtained if there exists an asset for which ωⱼ=1 and therefore wᵢ=0 for i≠j⁰, i.e., this may hold for a completely concentrated portfolio. Notably, if the weight of a subset made of m assets is zero, the entropy measure may have the maximum value of n−m. Therefore, the entropy measure may take values in [1, n] and its values may be interpreted as the effective number of bets. In addition, the normalized QDX entropy index may be introduced as:

$${QDX}_{ℐ} := {QDX}_{ℐ}^{( w , \sum )} = \frac{𝒩 - 1}{n - 1} \qquad ( 28 )$$

that takes values in [0, 1] and may indicate the distance from an ideal well-diversified portfolio. This value is 0 if the portfolio is concentrated in a single asset, and 1 if the diversification parity in equation (26) is satisfied. The diversification parity portfolio may be determined by solving the optimization problem:

ŵ_{dc}=argmax QDX_{I}^{(w,Σ)} (29)

subject to the balance constraint 1′w=1 and the no short-sell constraint w≥0¹⁰. The only assumption that may be needed to justify the use of the diversification parity approach may be the homogeneity of order one of the risk measure. In addition, the diversification measure may be computed with reference to different risk dimensions, i.e., both at the asset level as well as the sub-portfolio or factor level.

Continuing the example previously discussed with reference to FIG. 1, assume that the portfolio invests only in the first asset with weight w₁. The standard deviation of this portfolio may be expressed as σ=\sqrt{w₁²σ₁²}, and the risk contribution of the first asset maybe expressed as w₁σ₁. FIG. 2 illustrates a chart 200 to aid in understanding how to compare portfolios in terms of the QDX index. For example, consider a square having sides of length |w₁|σ₁. The area of this square may express the risk contribution of the first asset. Considering a portfolio with two assets, then, the risk attributed to the first asset may be γ₁. In FIG. 2, the shaded area w₁²σ₁²−γ₁² may measure the impact to diversification due to the first asset. A similar decomposition is also illustrated in FIG. 2 for the second asset and may be represented by the shaded zone having area w₂²σ₂²−γ₂². Therefore, the sum of the two shaded areas in FIG. 2 may be equal to QDX×σ. In FIG. 2, half the perimeter is the QDX measure. The different rectangles may have the same perimeter; however, the larger the difference between the two sides, the lower the diversification may be according to the QDX₂ entropy measure. The most diversified portfolio may be the one having the two sides equal.

### VI. Why Diversify Diversification

The importance of using partial variances and covariances, as well as the importance of building a diversification parity may be stressed in the following example. Considering the covariance matrix:

$$Σ = [ \begin{matrix}1 & 0.4 & 2.25 \\ 0.4 & 4 & 2.4 \\ 2.25 & 2.4 & 9\end{matrix} ]$$

where the three assets may have variances of 1, 4, and 9 and their cross correlations may respectively be 0.2, 0.5, and 0.4. An equally weight portfolio may be selected. This portfolio has variance of 2.67, QDX of 0.258, the effective number of bets N is 2.58, and the entropy index QDX₁ may be 0.79. The matrix of partial covariances and partial correlations between assets given the portfolio return may be computed. As previously suggested, a partial covariance may measure the covariance between two random variables, i.e., the weighted return of two assets, with the effect of a controlling random variable removed, i.e., the portfolio return. Those quantities may be checked, rather than the variances and covariances among assets. For this portfolio, the matrix Σ_{⋅|r}_{ₚ} of the partial covariances, the vector containing the QDXⱼ's and the vector matrix Rⱼ of QDX ratios are:

$${Σ}_{\cdot \vert {r}_{p}} = [ \begin{matrix}4.97 \% & - 7.00 \% & 2.03 \% \\ - 7.00 \% & 23.13 \% & - 16.13 \% \\ 2.03 \% & - 16.13 \% & 14.10 \%\end{matrix} ]$$

$${QDX}_{j} = [ \begin{matrix}0.030 \\ 0.141 \\ 0.086\end{matrix} ]$$

$${R}_{j} = [ \begin{matrix}12 \text{\textbar} \% \\ 55 \% \\ 33 \%\end{matrix} ]$$

Notice that for each row, the sum of the off-diagonal entries of the covariance matrix Σ_{⋅|r}_{ₚ} are equal and of opposite sign to the diagonal entries. The diagonal entries may be a measure of the orthogonal risks while the former may be a measure of the diversification component. In particular, for the equally weighted portfolio, the orthogonal risk related to the first asset may be equal to 4.97% and may be entirely eliminated due to interaction with the second and third asset. Indeed, 4.97%−7%+2.03%=0, which may mean that the residual risk of the first asset has a negative covariance with the residual risk of the second asset and positive covariance with the risk of the third asset. However, this portfolio is not well-balanced in terms of diversification because the three assets have residual risks with very difference variances (4.97%, 23.13%, and 14.1%). Therefore, the residual risk of the second asset accounts for 55% of the total residual risk, while the second and third asset have a contribution to the overall residual risk equal to 12% and 33%. For a given portfolio, the orthogonal risk related to the second asset may be eliminated via the interaction with the two other assets but in different proportions. That is, the fraction −7/4.97 may be due to the second asset and the fraction 2.03/4.97 may be due to the third asset. Similar assessments may be made for the second and third asset. Therefore, the portfolio may not be well-diversified because it may be largely exposed to the residual risk of the second asset. This risk may be mainly balanced by the interaction with the third asset (70%=14.10%/23.13%) and may only be in a limited way with the first asset (30%=7%/23.13%).

For at least these reasons, it may make sense to consider a diversification parity portfolio, i.e., to diversify the residual risk equally across assets. This portfolio may have the composition, w′=[48.03%, 15.27%, 36.70%] with a variance of 2.7, QDX=0.126 and QDX₁=1 and an effective number of bets equal to 3, which is exactly the number of portfolio components. For this portfolio, the relevant matrices become:

$${Σ}_{\cdot \vert {r}_{p}} = [ \begin{matrix}6.84 \% & - 3.42 \% & - 3.42 \% \\ - 3.42 \% & 6.84 \% & - 3.42 \% \\ - 3.42 \% & - 3.42 \% & 6.84 \%\end{matrix} ]$$

$${QDX}_{j} = [ \begin{matrix}0.042 \\ 0.042 \\ 0.042\end{matrix} ]$$

$${R}_{j} = [ \begin{matrix}33.33 \% \\ 33.33 \% \\ 33.33 \%\end{matrix} ]$$

Based on these matrices, the meaning of diversifying diversification becomes clearer. First, the residual risks may have all of the same variances (6.84%) or said another way, the assets have the same QDXⱼ (0.042). Second, these risks may be diversified interacting with the remaining assets in an equal manner. Indeed, all of the covariances terms may be equal to −3.42%, and the correlations between residual risks may be negative and equal to −50%.

Other portfolios, such as the global minimum variance portfolio and the maximum DR portfolio may not distribute the residual risks in a balanced manner because they may turn out to be concentrated in two assets. The global minimum variance portfolio may have a composition w′=[86%, 14%, 0%] with an effective number of bets equal to 2. This portfolio may be well-diversified but in a subset of the asset universe as shown in the following matrices:

$${Σ}_{\cdot \vert {r}_{p}} = [ \begin{matrix}18.31 \% & - 18.31 \% & 0 \% \\ - 18.31 \% & 18.31 \% & 0 \% \\ 0 \% & 0 \% & 0 \%\end{matrix} ]$$

$${QDX}_{j} = [ \begin{matrix}0.174 \\ 0.174 \\ 0.0\end{matrix} ]$$

$${R}_{j} = [ \begin{matrix}50 \% \\ 50 \% \\ 0 \%\end{matrix} ]$$

Similarly, the portfolio maximizing the DR may have a very extreme composition being invested mainly in the first two assets w′=[63%, 34%, 3%] and may have a variance of 3.5, entropy index as low as 0.55, and an effective number of bets N equal to 2.83. Although the first asset has the largest weight, the low value of the entropy index may be due to the fact that for this portfolio, the residual risk may be mainly concentrated in the second asset that accounts for 50% of the total residual variance, while the other two residual risks account for 25% each. Therefore, this portfolio may not be well-diversified. The relevant matrices are as follows:

$${Σ}_{\cdot \vert {r}_{p}} = [ \begin{matrix}13.77 \% & - 13.55 \% & - 0.22 \% \\ - 13.55 \% & 26.74 \% & - 13.19 \% \\ - 0.22 \% & - 13.19 \% & 13.40 \%\end{matrix} ]$$

$${QDX}_{j} = [ \begin{matrix}0.073 \\ 0.143 \\ 0.072\end{matrix} ]$$

$${R}_{j} = [ \begin{matrix}25 \% \\ 50 \% \\ 25 \%\end{matrix} ]$$

This example may clarify that in order to have a well-diversified portfolio, it may not be a question of minimizing the portfolio variance, maximizing the DR ratio, or maximizing the sum of partial variances but to have an equal contribution of each asset to this sum. From this perspective, even the equally-weighted portfolio may not be perfectly diversified.

The following Table 1 resumes these findings. Table one shows composition and diversification measures of different example portfolios. The following abbreviations are used. “Max Entr” refers to the diversification parity portfolio. “Max QDX” refers to the portfolio that maximizes the sum of partial variances. “EW” refers to an equally weighted portfolio. “GMV” refers to the global minimum variance portfolio with no short-selling constraint. “Max DR” refers to the portfolio that maximizes the diversification ratio. “EW*” refers to a portfolio that maximizes the QDX₁ index under the constraint of having the same volatility as the EW portfolio. Bold cells represent the optimal achieved value for each index across the different distribution strategies.

TABLE 1

| | Max | Max | | | Max | |
|---|---|---|---|---|---|---|
| | QDX_{I} | QDX | EW | GMV | DR | EW* |
| w₁ | 48% | 64% | 33% | 86% | 63% | 57% |
| w₂ | 15% | 36% | 33% | 14% | 34% | 17% |
| w₃ | 37% | 0% | 33% | 0% | 3% | 33% |
| R₁ | 33.33% | 50% | 11.78% | 46.32% | 25.54% | 36.68% |
| R₂ | 33.33% | 50% | 54.81% | 21.05% | 49.60% | 37.05% |
| R₃ | 33.33% | 0% | 33.41% | 32.64% | 24.86% | 37.05% |
| σ | 1.630 | 1.054 | 1.636 | 0.956 | 1.082 | 1.634 |
| DR | 1.157 | 1.290 | 1.222 | 1.195 | 1.293 | 1.176 |
| QDX | 0.126 | 0.348 | 0.258 | 0.132 | 0.320 | 0.155 |
| ENB | 3.000 | 2.000 | 2.580 | 2.000 | 2.098 | 2.994 |
| QDX_{I} | 1.000 | 0.500 | 0.790 | 0.500 | 0.549 | 0.997 |

In this table, the composition of two additional portfolios is included: the portfolio that maximizes the sum of residual variances and the portfolio that solve problem (29) but under the additional constraint of having the same volatility as the equally-weighted portfolio. The former portfolio may be concentrated in two assets, which may clarify the point that it may not be important to have a large QDX value but to equally distribute it across assets. The latter portfolio may indicate that even the composition of the equally-weighted portfolio may be modified to achieve the largest diversification, given a risk budget.

The QDX index is a new measure of diversification (QDX), which is bounded between 0 and 1 with a clear mathematical and geometrical interpretation, being based on the Euler decomposition formula. Its computation is straightforward, requiring only the portfolio composition and the covariance matrix. It may also be extended to homogeneous risk functions, as previously discussed.

### APPENDIX A. EIGENVALUES AND EIGENVECTORS OF/IN THE CONSTANT VOLATILITY AND CORRELATION CASE

Referring back to the covariance matrix in expression (13), the eigenvalues are solution of the equation:

$$det ( Σ - λ {I}_{n} ) = det ( c {σ}^{2} {1}_{n} {1}_{n}^{′} - ( λ - ( 1 - c ) {σ}^{2} ) {I}_{n} ) = det ( {1}_{n} {1}_{n}^{′} - \frac{( λ - ( 1 - c ) {σ}^{2} )}{c {σ}^{2}} {I}_{n} ) = 0. \qquad ( 26 )$$

The matrix 1ₙ1ₙ has n−1 zero eigenvalues and one eigenvalue equal to n. Therefore, for I=1, . . . , n−1, it follows that:

$$\frac{{λ}_{i} - ( 1 - c ) {σ}^{2}}{c {σ}^{2}} = 0 ,$$

i.e.:

λᵢ=(1−c)σ².

The largest eigenvalue is such that:

$$\frac{{λ}_{n} - ( 1 - c ) {σ}^{2}}{c {σ}^{2}} = n ,$$

so that:

λₙ=(1−c)σ²+cσ²n.

It may also be verified that the eigenvectors associated to λₙ are multiples of the unit vector 1ₙ. If its components are normalized, it may be determined that the equally weighted portfolio is the factor portfolio having the largest variance. The eigenvectors associated with the remaining eigenvalues may be interpreted as arbitrage portfolios because the sum of their components is zero.

### APPENDIX B. MULTIDIMENSIONAL RISK DECOMPOSITION AND DIVERSIFICATION

The use of a factor model may be used to represent the risk of the portfolio, such that:

r=B′f+ε,

with B being the f×n matrix of factor loadings, and such that w_{f}=Bwₙ collects the factor exposures. Given this factor model, the risk of the portfolio may be decomposed along three different dimensions: (i) assets (n), (ii) sub-portfolios (s) and (iii) factors (f).

### B.1 Risk Contribution of Assets: Calculation of γₙ and γ_{n,n}

The diversification power may be computed from any asset, factor, or sub-portfolio. The total amount of diversification may depend on the dimension used for the calculation.

In the factor model, the volatility of the portfolio in terms of asset portfolios wₙ may be expressed as:

σ=\sqrt{w′ₙB′Σ_{f}Bwₙ+w′ₙΩwₙ}, (30)

where Σ_{f} is the covariance matrix, but not necessarily diagonal, between the factors, and Ω refers to an n×n diagonal matrix containing the variances of the residuals. The asset risk-contribution may be expressed as:

γₙ=WₙΔₙ

where:

$${Δ}_{n} = \frac{\partial σ}{\partial {w}_{n}} = \frac{{B}^{′} {Σ}_{f} B + Ω}{σ} {w}_{n} .$$

The term represents

$$\frac{{B}^{′} {Σ}_{f} B}{σ}$$

the common factor sensitivity of the risk associated to single asset, while the second term, i.e.

$$\frac{Ω}{σ} ,$$

represents me idiosyncratic sensitivity of the asset. From expression (2), the vector y collecting the risk contribution of each asset may be recovered as:

$$γ = {W}_{n} \frac{\partial σ}{\partial {w}_{n}} = {W}_{n} ( \frac{{B}^{′} {Σ}_{f} B}{σ} + \frac{Ω}{σ} ) {w}_{n} . \qquad ( 31 )$$

Now, γⱼⱼ and yᵢⱼ may be computed as in expressions (18) and (19). In particular:

$${Δ}_{n , n} = \frac{\partial {γ}_{n}}{\partial {w}_{n}} = {Δ }_{n} + \frac{\partial {Δ}_{n}}{\partial {w}_{n}} {w}_{n} = {Δ}_{n} + [ \frac{{B}^{′} {Σ}_{f} B + Ω}{σ} + \frac{{Δ}_{n} {Δ}_{n}^{′}}{σ} ] {W}_{n} \qquad ( 32 )$$

so that the second level risk decomposition can be written as:

γ_{n,n}=WₙΔ_{n,n}.

Therefore, the computation of DIV is based on:

$${1}^{′} {W}_{n} [ \frac{{B}^{′} {Σ}_{f} B + Ω}{σ} - \frac{{Δ}_{n} {Δ}_{n}^{′}}{σ} ] {W}_{n} 1.$$

B.2 Risk Contribution of Sub-Portfolios: Calculation of γₛ and γ_{s,s}.

Considering a portfolio composed of several sub portfolios. We can let wₛ be an s×1 vector containing the weights of sub portfolios over the total portfolio such that 1ₛ′wₛ=1. This sub-portfolio can be related to wₙ by introducing a n×s matrix C such that Cwₛ=wₙ.

The volatility of the portfolio may be expressed in terms of the sub-portfolio wₛ as:

σ=\sqrt{w′ₛC′B′Σ_{f}BCwₛ+w′ₛC′ΩCwₛ}. (33)

The risk contribution γₛ may be expressed as:

γₛ=WₛΔₛ,

where:

$${Δ}_{s} = \frac{\partial σ}{\partial {w}_{s}} = \frac{{C}^{′} {B}^{′} {Σ}_{f} BC + {C}^{′} ΩC}{σ} {w}_{s} .$$

The second level decomposition applies at well. Based on:

$${Δ}_{s , s} = \frac{\partial {γ}_{s}}{\partial {w}_{s}} = {Δ}_{s} + \frac{\partial {Δ}_{s}}{\partial {w}_{s}} = {Δ}_{s} + [ \frac{{C}^{′} ( {B}^{′} Σ B + Ω ) C}{σ} - \frac{{Δ}_{s} {Δ}_{s}^{′}}{σ} ] {W}_{s} , \qquad ( 34 )$$

The second-order decomposition may be obtained and expressed as:

γ_{s,s}=WₛΔ_{s,s}

Therefore, the computation of DIV is based on:

$${1}_{s}^{′} {W}_{s} [ \frac{{C}^{′} ( {B}^{′} Σ B + Ω ) C}{σ} - \frac{{Δ}_{s} {Δ}_{s}^{′}}{σ} ] {W}_{s} {1}_{s} .$$

B.3 Risk Contribution of Factors: Calculation of γ_{f} and γ_{f,f}

The volatility (standard deviation of returns) of the portfolio in terms of factor portfolios may be expressed as:

σ=\sqrt{w′_{f}B′Σ_{f}Bw_{f}+w′ₙC′ΩCwₙ} (35)

Due to the presence of the idiosyncratic risk, the portfolio volatility may not be homogeneous with respect to the factor weights w_{f}. Therefore, the factor risk contributions may not sum to the overall portfolio risk. However, this issue may be addressed and a coherent decomposition according to the dimension f may be found.

In general, there may be more assets than factors, i.e. n>f. The factor portfolio may be expressed as:

w_{f}=Bwₙ

where:

wₙ=B⁺w_{f}+(Iₙ−B⁺B)wₙ,

and where B⁺=B′(BB′)⁻¹ is the Moore-Penrose inverse of B. Further, Δ_{f} may be calculated using a modification of the previous equation and where wₙ⁺=B⁺w_{f}. For simplicity, let wₙ=B⁺w_{f}. Therefore:

$${Δ}_{f} = \frac{\partial σ}{\partial {w}_{f}} = {( \frac{\partial {w}_{n}}{\partial {w}_{f}} )}^{′} \frac{\partial σ}{\partial {w}_{n}} = {( {BB}^{′} )}^{- 1} B \frac{\partial σ}{\partial {w}_{n}} = \frac{{Σ}_{f} B + {( {BB}^{′} )}^{- 1} BΩ}{σ} {w}_{n}$$

However, due to the use of wₙ⁺, the sum of the factor risk contributions may not sum to the overall risk. In fact, given that Euler's theorem does not hold, it may be verified that:

w′_{f}Δ_{f}≠σ

The equality can be restored if Δ_{f} is adjusted to:

$${Δ}_{f} = \frac{Σ B + {z ( {BB}^{′} )}^{- 1} B Ω}{σ} {w}_{n}$$

where z is a normalization factor given by:

$$z = \frac{{w}_{n}^{′} Ω {w}_{n}}{{{w}_{f}^{′} ( {BB}^{′} )}^{- 1} B Ω {w}_{n}}$$

Now, γ_{ff} may be recovered. It may be shown that γ_{f}=W_{f} Δ_{f}, where W_{f} is a diagonal matrix containing the weights w_{f}. Using:

G=B′(BB′)⁻¹

and:

$$dz = \frac{\partial z}{\partial {w}_{f}} = 2 \frac{{w}_{f}^{′} {G}^{′} Ω {w}_{n} {G}^{′} Ω {w}_{n} - {w}_{n}^{′} Ω {w}_{n} {GBG}^{′} Ω {w}_{n}}{{( {w}_{f}^{′} {G}^{′} Ω {w}_{n} )}^{2}}$$

It may be shown that:

$${Δ}_{f , f} = \frac{\partial {Δ}_{f}}{\partial {w}_{f}} = {Δ}_{f} + \frac{\partial {Δ}_{f}}{\partial {w}_{f}} {W}_{f} = {Δ}_{f} + [ \frac{Σ + {G}^{′} Ω {w}_{n} {dz}^{′} + {zG}^{′} Ω G}{σ} - \frac{{Δ}_{f} {Δ}_{f}^{′}}{σ} ] {W}_{f} \qquad ( 36 )$$

so that:

γ_{f,f}=W_{f}Δf,f

Therefore, the computation of DIV is based on:

$${1}_{f}^{′} {W}_{f} [ \frac{Σ + {G}^{′} Ω {w}_{n} {dz}^{′} + {zG}^{′} ΩG}{σ} - \frac{{Δ}_{f} {Δ}_{f}^{′}}{σ} ] {W}_{f} {1}_{f}$$

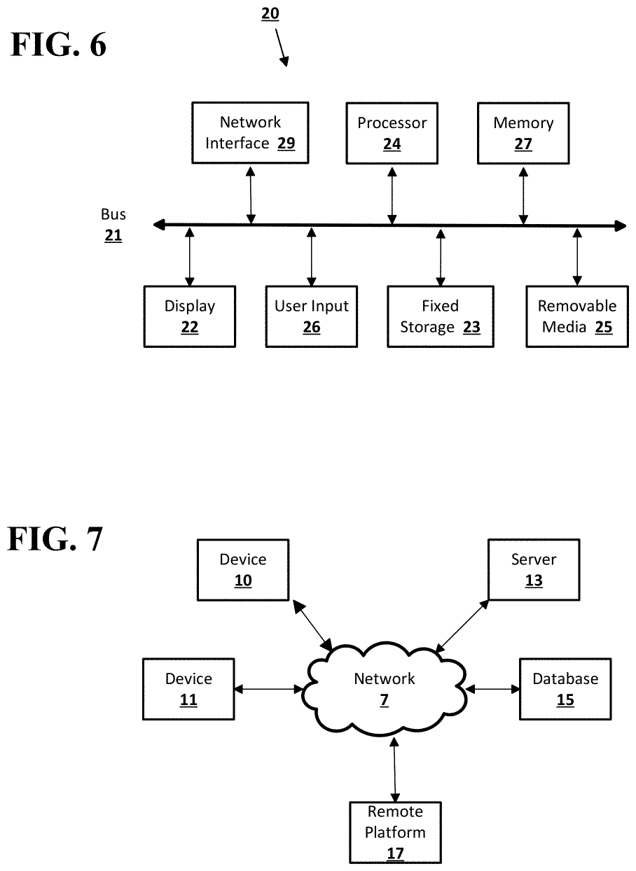

Embodiments of the presently disclosed subject matter may be implemented in and used with a variety of component and network architectures. FIG. 6 is an example computing device 20 suitable for implementing embodiments of the presently disclosed subject matter. The device 20 may be, for example, a desktop or laptop computer, or a mobile computing device such as a smart phone, tablet, or the like. The device 20 may include a bus 21 which interconnects major components of the computer 20, such as a central processor 24, a memory 27 such as Random Access Memory (RAM), Read Only Memory (ROM), flash RAM, or the like, a user display 22 such as a display screen, a user input interface 26, which may include one or more controllers and associated user input devices such as a keyboard, mouse, touch screen, and the like, a fixed storage 23 such as a hard drive, flash storage, and the like, a removable media component 25 operative to control and receive an optical disk, flash drive, and the like, and a network interface 29 operable to communicate with one or more remote devices via a suitable network connection.

The bus 21 allows data communication between the central processor 24 and one or more memory components, which may include RAM, ROM, and other memory, as previously noted. Typically, RAM is the main memory into which an operating system and application programs are loaded. A ROM or flash memory component can contain, among other code, the Basic Input-Output system (BIOS) which controls basic hardware operation such as the interaction with peripheral components. Applications resident with the computer 20 are generally stored on and accessed via a computer readable medium, such as a hard disk drive (e.g., fixed storage 23), an optical drive, floppy disk, or other storage medium.

The fixed storage 23 may be integral with the computer 20 or may be separate and accessed through other interfaces. The network interface 29 may provide a direct connection to a remote server via a wired or wireless connection. The network interface 29 may provide such connection using any suitable technique and protocol as will be readily understood by one of skill in the art, including digital cellular telephone, WiFi, Bluetooth®, near-field, and the like. For example, the network interface 29 may allow the computer to communicate with other computers via one or more local, wide-area, or other communication networks, as described in further detail below.

Many other devices or components (not shown) may be connected in a similar manner (e.g., document scanners, digital cameras and so on). Conversely, all of the components shown in FIG. 6 need not be present to practice the present disclosure. The components can be interconnected in different ways from that shown. The operation of a computer such as that shown in FIG. 6 is readily known in the art and is not discussed in detail in this application. Code to implement the present disclosure can be stored in computer-readable storage media such as one or more of the memory 27, fixed storage 23, removable media 25, or on a remote storage location.

FIG. 7 shows an example network arrangement according to an embodiment of the disclosed subject matter. One or more devices 10, 11, such as local computers, smart phones, tablet computing devices, and the like may connect to other devices via one or more networks 7. Each device may be a computing device as previously described. The network may be a local network, wide-area network, the Internet, or any other suitable communication network or networks, and may be implemented on any suitable platform including wired and/or wireless networks. The devices may communicate with one or more remote devices, such as servers 13 and/or databases 15. The remote devices may be directly accessible by the devices 10, 11, or one or more other devices may provide intermediary access such as where a server 13 provides access to resources stored in a database 15. The devices 10, 11 also may access remote platforms 17 or services provided by remote platforms 17 such as cloud computing arrangements and services. The remote platform 17 may include one or more servers 13 and/or databases 15.

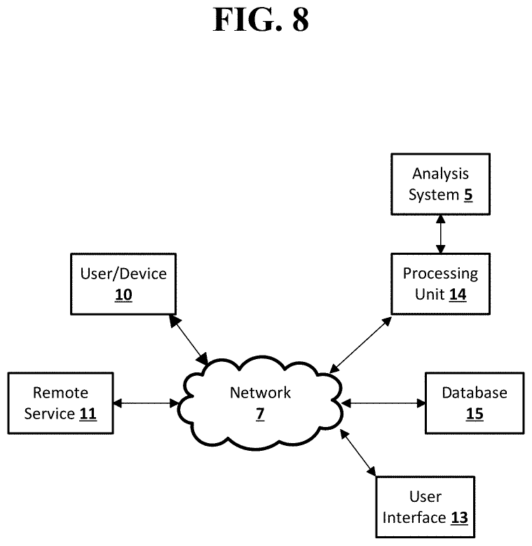

FIG. 8 shows an example arrangement according to an embodiment of the disclosed subject matter. One or more devices or systems 10, 11, such as remote services or service providers 11, user devices 10 such as local computers, smart phones, tablet computing devices, and the like, may connect to other devices via one or more networks 7. The network may be a local network, wide-area network, the Internet, or any other suitable communication network or networks, and may be implemented on any suitable platform including wired and/or wireless networks. The devices 10, 11 may communicate with one or more remote computer systems, such as processing units 14, databases 15, and user interface systems 13. In some cases, the devices 10, 11 may communicate with a user-facing interface system 13, which may provide access to one or more other systems such as a database 15, a processing unit 14, or the like. For example, the user interface 13 may be a user-accessible web page that provides data from one or more other computer systems. The user interface 13 may provide different interfaces to different clients, such as where a human-readable web page is provided to a web browser client on a user device 10, and a computer-readable API or other interface is provided to a remote service client 11.

The user interface 13, database 15, and/or processing units 14 may be part of an integral system or may include multiple computer systems communicating via a private network, the Internet, or any other suitable network. One or more processing units 14 may be, for example, part of a distributed system such as a cloud-based computing system, search engine, content delivery system, or the like, which may also include or communicate with a database 15 and/or user interface 13. In some arrangements, a, a machine learning model 5 may provide various prediction models, data analysis, or the like to one or more other systems 13, 14, 15.

More generally, various embodiments of the presently disclosed subject matter may include or be embodied in the form of computer-implemented processes and apparatuses for practicing those processes. Embodiments also may be embodied in the form of a computer program product having computer program code containing instructions embodied in non-transitory and/or tangible media, such as floppy diskettes, CD-ROMs, hard drives, USB (universal serial bus) drives, or any other machine readable storage medium, such that when the computer program code is loaded into and executed by a computer, the computer becomes an apparatus for practicing embodiments of the disclosed subject matter. Embodiments also may be embodied in the form of computer program code, for example, whether stored in a storage medium, loaded into and/or executed by a computer, or transmitted over some transmission medium, such as over electrical wiring or cabling, through fiber optics, or via electromagnetic radiation, such that when the computer program code is loaded into and executed by a computer, the computer becomes an apparatus for practicing embodiments of the disclosed subject matter. When implemented on a general-purpose microprocessor, the computer program code segments configure the microprocessor to create specific logic circuits.

In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Embodiments may be implemented using hardware that may include a processor, such as a general purpose microprocessor and/or an Application Specific Integrated Circuit (ASIC) that embodies all or part of the techniques according to embodiments of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to embodiments of the disclosed subject matter.

The foregoing description, for purpose of explanation, has been described with reference to specific embodiments. However, the illustrative discussions above are not intended to be exhaustive or to limit embodiments of the disclosed subject matter to the precise forms disclosed. Many modifications and variations are possible in view of the above teachings. The embodiments were chosen and described in order to explain the principles of embodiments of the disclosed subject matter and their practical applications, to thereby enable others skilled in the art to utilize those embodiments as well as various embodiments with various modifications as may be suited to the particular use contemplated.

1. A method of achieving a desired level of diversification of a portfolio comprising:
determining a quantity of a plurality of assets in the portfolio;
determining a weight for each of the assets of the plurality of assets in the portfolio;
determining a variance for each of the assets of the plurality of assets in the portfolio;
determining a volatility contribution for each of the assets of the plurality of assets in the portfolio;
determining a variance of the portfolio;
determining a first diversity index of the portfolio based on the determined quantity of assets, weight, variance, volatility contribution, and variance;
determining a second diversity index of the portfolio based on a modification of a metric of the portfolio; and
based on a comparison of the first diversity index and the second diversity index, adjusting the portfolio.

2. The method of claim 1, wherein the assets comprise memory storage devices.

3. The method of claim 2, wherein the diversity indices indicate a diversification of the type of computer memory storage devices.

4. The method of claim 1, wherein the assets comprise biological species.

5. The method of claim 1, wherein the assets comprise data objects.

6. The method of claim 1, wherein the modified metric is the quantity of assets in the portfolio.

7. The method of claim 1, wherein the modified metric is the weight of a first asset.

8. The method of claim 1, wherein the modified metric is the weight of a first asset and the quantity of assets in the portfolio.

9. The method of claim 1, wherein adjusting the portfolio further comprises removing an asset from the portfolio.

10. The method of claim 1, wherein the adjusting the portfolio further comprises adding an asset to the portfolio.

11. The method of claim 1, wherein adjusting the portfolio further comprises modifying the weight of a first asset in the portfolio.

12. The method of claim 1, wherein adjusting the portfolio further comprises replacing a first asset with a different second asset.

13. The method of claim 1, wherein the second diversity index indicates a greater diversity of the portfolio than the first diversity index.

14. The method of claim 1, wherein the first and second diversity indicia is calculated as:
$$QDX = \frac{{\sum }_{i = 1}^{n} ( {w}_{i}^{2} {σ}_{i}^{2} - {γ}_{i}^{2} )}{{σ}^{2} + {\sum }_{i = 1}^{n} ( {w}_{i}^{2} {σ}_{i}^{2} - {γ}_{i}^{2} )} ,$$
where n is the quantity of assets in the portfolio, wᵢ is the weight of asset i in the portfolio, σᵢ² is the variance of asset i, γᵢ² is the square of the volatility contribution of asset i to the total volatility of the portfolio, and σ² is the variance of the portfolio.

15. The method of claim 1, where first and second diversity indicia may assume a value from 0 to 1.

16. The method of claim 1, wherein the portfolio is adjusted according to the modification of the metric.

17. The method of claim 1, wherein the second diversity index corresponds to a lesser diversity of the portfolio than the first diversity index.

18. The method of claim 1, wherein the weight of a first asset in the portfolio exceeds a predetermined, non-zero threshold.
